(19) United States
(12) Patent Application Publication
(10) Pub. No.: US 2008/0144313 A1
(43) Pub. Date: Jun. 19, 2008

(54) LIGHT GUIDES AND LUMINOUS INPUTS HAVING THE SAME

(75) Inventors: Kenneth Zhao, Shenzhen City (CN); Jia-Gui Zhou, Shenzhen City (CN); Ming Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/861,315

(22) Filed: Sep. 26, 2007

(30) Foreign Application Priority Data
Dec. 14, 2006 (CN) 200610201300.1

(51) Int. Cl. F21V 8/00; F21V 7/04

(52) U.S. Cl. 362/241; 362/346

(57) ABSTRACT

A kind of luminous input is disclosed. The luminous input includes an input element, a light guide, and a plurality of LEDs. The light guide defines a hole for receiving the input element, and includes a reflection part and a light transmission part around the hole. The reflection part includes a first reflection surface and a second reflection surface opposite each other. The second reflection surface is tilted at an angle relative to the first reflection surface. Light emitted by the LEDs is sequently reflected by the first and second reflection surface, then passes through the light transmission part. The luminous input is low in height and is efficient in using the light.

### BACKGROUND

1. Technical Field

The present invention relates to light guides, and particularly to light guides for luminous inputs.

2. General Background

To facilitate the use of electronic devices in the dark or in low light conditions, manufacturers of electronic devices are gradually adopting luminous inputs to replace the conventional non-luminous inputs. The current or conventional electronic devices, with luminous inputs, usually include LEDs (light-emitting diodes) and light guides under input elements in order to illuminate the input elements.

FIG. 8 shows a conventional light guide. The light guide 80 includes a reflection plate 81. A LED 82 is placed at a side of the reflection plate 81. The reflection plate 81 includes a plurality of reflection surfaces 83 at a bottom side of the reflection plate 81. Light generated by the LED 82 is reflected by the reflection surfaces 83 and is transmitted upwardly. The light guide 80 further includes a light transmission area 84 above the reflection plate 81. An input element such as a rotary wheel or keypad (not shown) is placed above the light transmission area 84.

However, having the light guide 80 below the input element increases the thickness of the electronic device. Furthermore, if the input element is opaque or light-tight, the input element will block a part of the LED light and thus the luminous input to the input element is affected and thus the efficiency of the light from the LED 82 will be low.

Therefore, what is needed is a light guide, for a luminous input, which improves the efficiency of the light from the LED without increasing the thickness of the luminous input.

### SUMMARY

A light guide is disclosed. The light guide defines a hole configured for receiving an input element. The light guide includes a reflection part and a light transmission part around the hole. The reflection part includes a first reflection surface and a second reflection surface opposite each other. The second reflection surface is tilted at an angle relative to the first reflection surface. The first reflection surface and the second reflection surface are configured for reflecting light sequentially, and the light transmission part is configured for transmitting light reflected by the second reflection surface.

Further features and advantages will be provided or will become apparent in the course of the following detailed description.

### BRIEF DESCRIPTION OF THE DRAWINGS

FIG. 1 is a front view of an electronic device having a luminous input according to a preferred embodiment of the present invention;

FIG. 2 is an isometric view of the luminous input of FIG. 1;

FIG. 3 is a partly sectional view of FIG. 2;

FIG. 4 is an isometric view of a light guide of the luminous input of FIG. 2;

FIG. 5 is an isometric view of the light guide reversed relative to FIG. 4;

FIG. 6 is a schematic view showing a horizontal light transmission path in the light guide of FIG. 4;

FIG. 7 is a schematic view showing a vertical light transmission path in the light guide of FIG. 4; and

FIG. 8 is a schematic, side view of a light guide according to a related art.

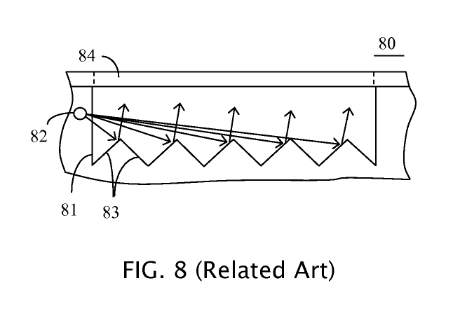

### DETAILED DESCRIPTION OF THE EMBODIMENT

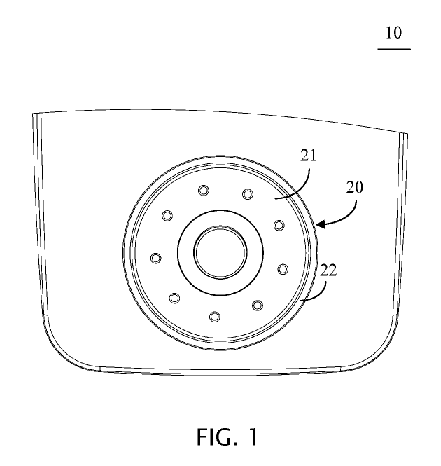

Referring to FIG. 1, an electronic device with a luminous input according to a preferred embodiment of the present invention is disclosed. The luminous input 20 is assembled on a front side of the electronic device 10. The luminous input 20 includes an input element 21 and a light guide 22. In this embodiment, the input element 21 is a rotary wheel.

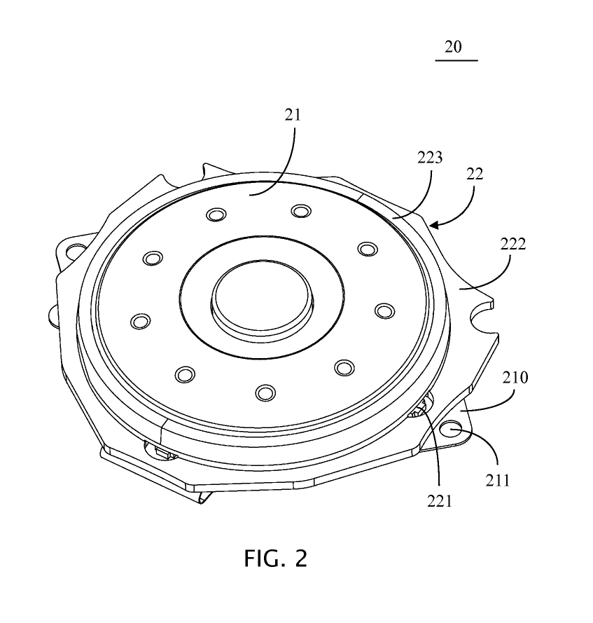

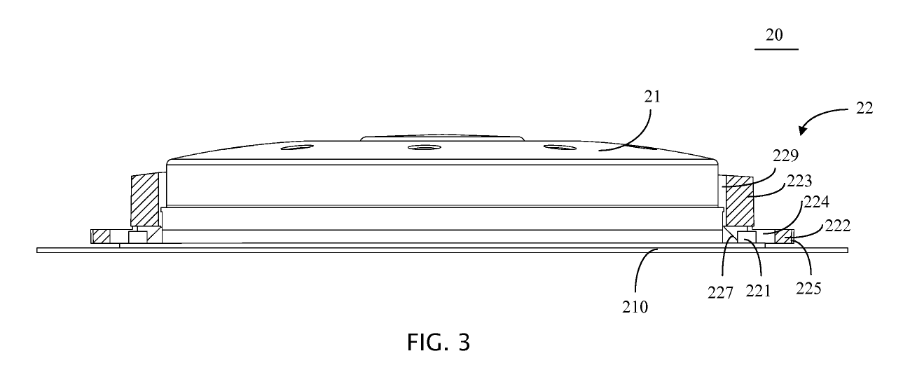

FIG. 2 and FIG. 3 show the luminous input 20 of FIG. 1. The luminous input 20 further includes a base 210. The rotary wheel 21 is assembled on the base 210. The base 210 defines a plurality of holes 211. The holes 211 are used to attach or fasten the base 210 to the electronic device 10.

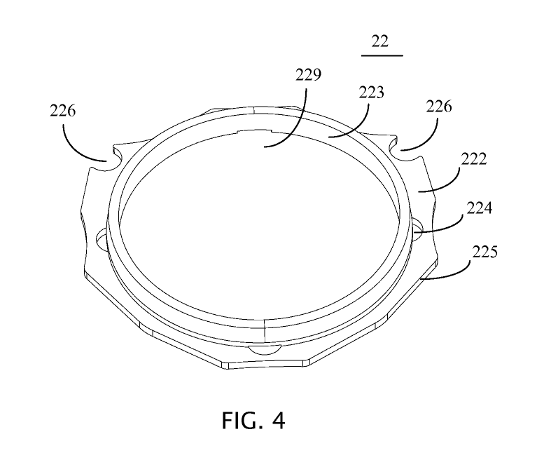

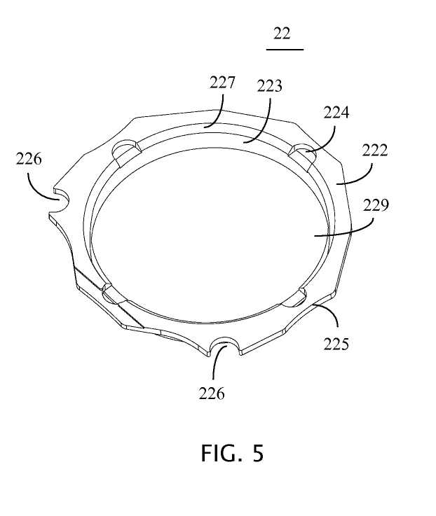

FIG. 4 and FIG. 5 show the light guide 22 at reversed angle of view relative to each other. The light guide 22 is made of transparent resin materials. The light guide 22 defines a hole 229 for receiving the rotary wheel 21. The light guide 22 includes a reflection part 222 and a light transmission part 223 around the hole 229. The shape of the reflection part 222 is approximately a polygonal prism. An outer surface 225 and an inner surface 227 of the reflection part 222 are painted with reflective material, thereby forming a first and second reflection surface respectively. The second reflection surface 227 is a conical surface and is tilted at an angle (e.g., 45°) relative to the first reflection surface 225. The reflection part 222 further defines four evenly disposed holes 224 at the inside edge of the reflection part 222. Each hole 224 is configured for receiving an LED (light emitting diode) 221 (See FIG. 3). The reflection part 222 also defines two half holes 226 in an outer edge thereof. The two half holes 226 are used to attach or fasten the light guide 22 to the electronic device 10.

The light transmission part 223 extends upwardly from an inside edge of the reflection part 222. The light transmission part 223 is annular.

Referring to FIG. 3, the diameter of the hole 229 is a little larger than the diameter of the rotary wheel 21, the hole 229 receives the rotary wheel 21. The height of the light guide 22 is smaller than the height of the rotary wheel 21, thus, the height of the luminous input 20 is equal to the height of the rotary wheel 21.

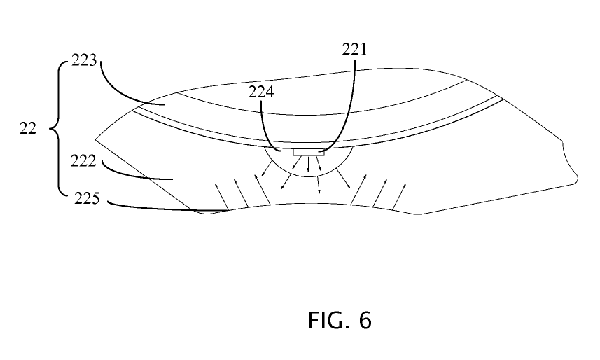

Referring to FIG. 6, the LEDs 221 are opposite the first reflection face 225. The LEDs 221 emit light and direct the light to pass through the transparent resin of the reflection part 222, and reach the first reflection surface 225. Then the light is reflected by the first reflection surface 225. Due to the shape of the first reflection surface 225 is a dodecagonal (twelve sided polygon) prism and the four LEDs are disposed evenly in a circle, the reflected light is distributed evenly in the reflection part 222.

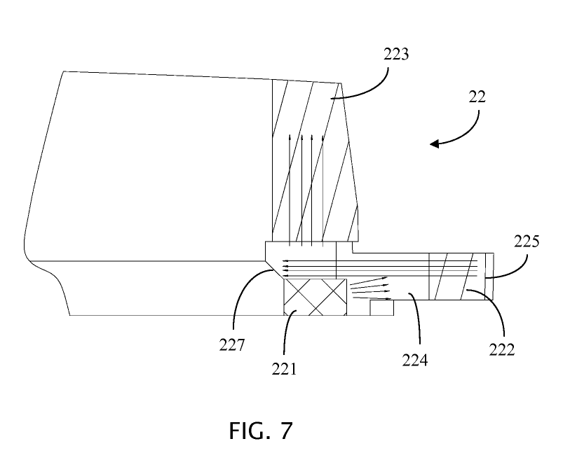

Referring to FIG. 7, the light reflected by the first reflection surface 225 reaches the second reflection surface 227 and is further reflected by the second reflection surface 227. Accordingly, a light path of the light reflected by the first reflection surface 225 changes from a horizontal direction to a vertical direction. The light reflected by the second reflection surface 227 passes through the light transmission part 223, then spread out of the electronic device 10 in a ring form corresponding to the form of the light transmission part 223. The transmission path of the light emitted by the LEDs 25 do not reaches the rotary wheel 21, thus, the rotary wheel 21 can not block the light, and a efficiency of the light is high. Consequently, an observer can see a bright even-lighted ring on the electronic device 10.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A luminous input comprising:
an input element;
a light guide comprising a hole for receiving the input element, a reflection part around the hole, and a light transmission part around the hole, wherein the reflection part comprises a first reflection surface and a second reflection surface opposite each other, the second reflection surface is tilted at an angle relative to the first reflection, the first reflection surface and the second reflection surface are configured for reflecting light sequentially, and the light transmission part is configured for transmitting light reflected by the second reflection surface; and
a plurality of LEDs configured for directing light to the first reflection surface.

2. The luminous input of claim 1, wherein the second reflection surface is tilted at 45° relative to the first reflection surface.

3. The luminous input of claim 1, wherein the second reflection surface is a cone surface.

4. The luminous input of claim 1, wherein the shape of the first reflection surface is a polygonal prism.

5. The luminous input of claim 1, wherein the light transmission part is a ring.

6. The luminous input of claim 1, further comprising holes defined in edges of the reflection part for receiving the LEDs.

7. The luminous input of claim 1, wherein the input element is a rotary wheel.

8. A light guide comprising:
a hole configured for receiving an input element;
a reflection part around the hole comprising a first reflection surface and a second reflection surface opposite each other, wherein the second reflection surface is tilted at an angle relative to the first reflection surface and is configured for enclosing an input element, and the first reflection surface and the second reflection surface are configured for reflecting light sequentially; and
a light transmission part around the hole configured for transmitting light reflected by the second reflection surface.

9. The light guide of claim 8, wherein the second reflection surface is tilted at 45° relative to the first reflection surface.

10. The light guide of claim 8, wherein the second reflection surface is a cone surface.

11. The light guide of claim 8, wherein the shape of the first reflection surface is a polygonal prism.

12. The light guide of claim 8, wherein the light transmission part is a ring.

13. The light guide of claim 8, further comprising holes defined in edges of the reflection part for receiving LEDs.
